(19) United States
(12) Patent Application Publication
(10) Pub. No.: US 2026/0359420 A1
(43) Pub. Date: Nov. 12, 2026

(54) SYSTEMS AND METHODS FOR CRYPTOGRAPHY BILL OF PROCESSES (CBOP)

(71) Applicant: Wells Fargo Bank, N.A., San Francisco, CA (US)

(72) Inventors: Jeffrey J. Stapleton, O'Fallon, MO (US); Peter Bordow, Fountain Hills, AZ (US)

(73) Assignee: Wells Fargo Bank, N.A., San Francisco, CA (US)

(21) Appl. No.: 19/202,712

(22) Filed: May 8, 2025

(51) Int. Cl. G06F 21/52; H04L 9/32

(52) U.S. Cl. CPC G06F 21/52; H04L 9/32

(57) ABSTRACT

The arrangements disclosed herein relate to systems, apparatus, methods, and non-transitory computer readable media for creating a first Cryptography Bill of Processes (CBOP) object from a first enterprise solution by monitoring calls made by the first enterprise solution, wherein the CBOP object includes a cryptography record comprising cryptographic operation information of the first enterprise solution, a protocol record comprising protocol information of at least one protocol used by the first enterprise solution, and a flow record comprising connection information of at least one second enterprise solution connected to the first enterprise solution. The first enterprise solution is updated, and in response to updating the first enterprise solution, a second CBOP object is created from the first enterprise solution.

### BACKGROUND

Enterprises typically employ a large number of cryptographic solutions (e.g., cybersecurity products) for a significant number of applications and services, in order to meet government regulations, industry standards, and internal practices. For instance, an enterprise such as financial institutions may employ cryptographic solutions from many providers to meet the cryptographic demands for various applications and services, such as online banking, browsers, digital wallets, cryptocurrency, Automated Teller Machines (ATMs), Point of Sale (PoS) systems, and so on. An enterprise audits its overall cybersecurity processes to evaluate security performance with regard to the customer and enterprise data and to determine whether the relevant government regulations, industry standards, and internal practices are met.

While a provider of a cryptographic solution (e.g., manufacturers of hardware, firmware or software cybersecurity products) may have intimate knowledge of the operational characteristics, attributes, and hardware/software requirements of that cryptographic solution, it may be extremely challenging for an enterprise that onboards the cryptographic solution as one of the myriads of cryptographic solutions for its many applications and services to parse through all cryptographic and non-cryptographic processes that may be running to determine such operational characteristics, attributes, and hardware/software requirements of the cryptographic solution. Often times, even providers of cryptographic solutions may not properly document the operational characteristics, attributes, and hardware/software requirements of cryptographic solutions.

For example, due to the lack of access to the source code by the enterprise for the sake of the manufacturer's privacy and intellectual property, processes that may be apparent to the provider who has generated the executable code for those processes may not be apparent to the enterprise. Details of cryptographic processes are often not available in product specifications submitted by the provider, and when they are available, the details may or may not be applicable to or even turned on for the products and services of the provider, which may have unique requirements. Moreover, due to the complexity of software ecosystem which requires a large number of different cryptographic solutions from many different providers to collaborate, the enterprise and even the providers themselves lack the knowledge of the influence of the other cryptographic solutions on any given cryptographic solution.

Accordingly, documenting the software, firmware, and hardware components of a cybersecurity product, appliance or application or even of an Information Technology (IT) product in general remains problematic and challenging. While Software Bill of Materials (SBOM) and Cryptographic Bill of Materials (CBOM) such as those envisioned by the OWASP CycloneDX project are fundamental to any cybersecurity program, they are typically limited to source code scans and manual reviews.

### SUMMARY

The arrangements disclosed herein relate to systems, methods, non-transitory computer-readable media, and apparatuses for creating a first Cryptography Bill of Processes (CBOP object) from a first enterprise solution by monitoring calls made by the first enterprise solution, wherein the CBOP object includes a cryptography record comprising cryptographic operation information of the first enterprise solution, a protocol record comprising protocol information of at least one protocol used by the first enterprise solution, and a flow record comprising connection information of at least one second enterprise solution connected to the first enterprise solution. The first enterprise solution is updated, and in response to updating the first enterprise solution, a second CBOP object is created from the first enterprise solution

These and other features, together with the organization and manner of operation thereof, will become apparent from the following detailed description when taken in conjunction with the accompanying drawings.

### BRIEF DESCRIPTION OF THE DRAWINGS

FIG. 1 is a block diagram illustrating an example Cryptography Bill of Processes (CBOP) object, according to various arrangements.

FIG. 2 is a flowchart diagram illustrating an example method for generating and using the CBOP object, according to various arrangements.

FIG. 3 is a block diagram illustrating an example computing system suitable for implementing the CBOP method and the CBOP object, according to various arrangements.

### DETAILED DESCRIPTION

The arrangements described herein relate to systems, apparatuses, methods, and non-transitory computer-readable media for implementing Cryptography Bill of Processes (CBOP) solution to extract, describe, document, and manage bills of processes for cryptography operations. For instance, the CBOP identifies cryptographic algorithms, key sizes, mode of operations, functions, protocols, and intentional usage, to establish and maintain cryptographic architectures of computer systems, servers, devices, and enterprises.

As used herein, an enterprise solution (e.g., a cryptographic algorithm, solution, product, appliance, or application) refers to one or more of software, firmware, or hardware provided (e.g., downloaded, loaded, or otherwise installed) to one or more devices, servers, and datacenters of an enterprise (e.g., an organization, a company, a school, and so on) to meet a particular need or achieve a particular purpose, such as to provide cryptographic and cybersecurity capabilities for products and services (e.g., software, appliances, or applications) of the enterprise. Within the context of financial institutions, the products and services of the enterprise include online banking, browsers, digital wallets, cryptocurrency, ATMs, PoS systems, and so on. A enterprise solution can generate cryptographic material, encrypt data, decrypt data, encrypt another cryptographic material, decrypt another cryptographic material, sign data, verify data, signcrypt data, and so on. Examples of the cryptographic material include a cryptographic key (e.g., a private key, a public key, a symmetric key, an asymmetric key, a secret key, a key encryption key, and so on), information (e.g., a secret parameter, a random number, a seed, a key component, a key share, an initialization vector, and so on) used to generate or derive a cryptographic key, authentication code, and so on. Each enterprise solution can be provided (e.g., the code thereof is generated) by a provider (e.g., a vendor). For a given use case, the enterprise may have at least one or a plurality of enterprise solutions from different providers running sequentially, simultaneously, or a combination thereof, to provide cybersecurity capabilities.

A CBOP solution described herein can augment the enterprise cryptographic inventory, cryptographic architecture and its journey towards cryptographic agility for the enterprise solutions employed by an enterprise. A CBOP solution analyzes other products (e.g., the enterprise solutions) that perform cryptographic functions, detects cryptographic materials, cryptographic functions, and produces a CBOP object with metadata. In other words, CBOP solution detects, monitors, analyzes, and interprets enterprise solutions using cryptography to generate a CBOP object containing metadata documenting the cryptographic usage.

In some examples, a CBOP object is a data object (e.g., schema, data element, or data structure) that captures cryptographic architecture information. In some examples, a CBOP object includes or references Cryptography Bill of Materials (CBOM) information, Software Bill of Materials (SBOM) information, Software as a Service Bill of Materials (SaaSBOM), Hardware Bill of Materials (HBOM), Machine Learning Bill of Materials (ML-BOM), Operations Bill of Materials (OBOM), Manufacturing Bill of Materials (MBOM), Vulnerability Disclosure Report (VDR), Vulnerability Exploitability eXchange (VEX), Bill of Materials (BOM), Bill of Vulnerabilities (BOV), or CycloneDX Attestations (CDXA), or other relevant BOM information. The CBOP object includes minimal data elements for interoperability.

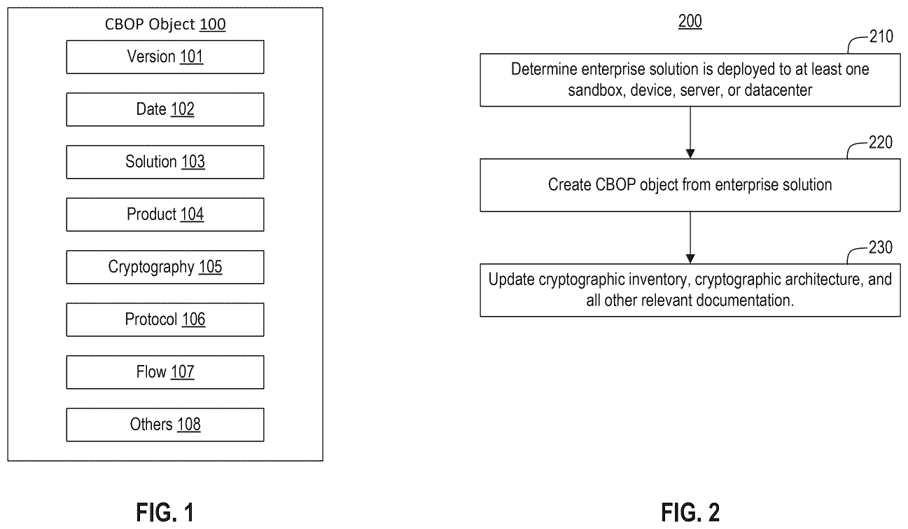

FIG. 1 is a block diagram illustrating an example CBOP object 100, according to various arrangements. The CBOP object 100 can be created for an enterprise solution and includes fields such as one or more of a version 101, date 102, solution 103, product 103, cryptography 105, protocol 106, flow 107, and others 108 for the enterprise solution.

The version 101 is an indicator that identifies a software release of the CBOP object structure of the CBOP object 100. In some examples, the version 101 can be defined using a numeric format, e.g., the “major.minor,patch” format, where a version 101 of 1.0.0 is the first published release of the CBOP object structure of the CBOP object 100. The version 101 of the CBOP object 100 is different from the version of the software/firmware for which the CBOP object 100 is generated, and is different from the versions of the CBOM, SBOM, SaaSBOM, HBOM, ML-BOM, OBOM, MBOM, VDR, VEX, BOM, BOV, or CDXA referenced or included in the CBOP object 100.

The date 102 indicates a date by which the CBOP object 100 is created, generated, downloaded, or published. In some examples, the date 102 can be defined using a numeric format, e.g., the “yyyy.mm.dd.hh.mm.ss” format of a timestamps indicate a year, month, day, hour, minute, and second, respectively. In some examples, the date 102 can include a Time Stamp Token (TST) corresponding to the date 102.

The solution 103 includes a solution record or a sequence of two or more solution records that each provides a solution name, solution identifier, status (e.g., development, test, production, decommissioned), lifecycle information (e.g., development date, test date, production date, decommissioned date), and so on of the enterprise solution.

The product 104 includes product record or a sequence of two or more product records that each provides a manufacturer, make, model, and so on. In some examples, each product record includes at least one of a CBOM, SBOM, SaaSBOM, HBOM, ML-BOM, OBOM, MBOM, VDR, VEX, BOM, BOV, or CDXA. Although in some examples, at least one product record is included in the product 104, in other examples, the field of the product 104 can be empty.

The cryptography 105 includes a cryptography record or a sequence of two or more cryptography records that each provides cryptographic operation information such as an algorithm identifier, size information (e.g., key length, hash length, and so on), usage information (e.g., encryption, Hash-Based Message Authentication Code (HMAC), digital signature, and so on), key type (symmetric, asymmetric, and so on), entropy source, and lifecycle information (e.g., generation date, begin date, end date, destruction date, archive date, and so on). Although in some examples, at least one cryptography record is included in the cryptography 105, in other examples, the field of the cryptography 105 can be empty.

The protocol 106 includes a protocol record or a sequence of one or more protocol records that each provides a protocol identifier, protocol version, and other relevant parameters. Although in some examples, at least one protocol record is included in the protocol 106, in other examples, the field of the protocol 106 can be empty.

The flow 107 includes a flow record or a sequence of one or more flow records that each provides connection information from one enterprise solution (e.g., a first enterprise solution) to one or more other enterprise solutions (e.g., second enterprise solutions). A first enterprise solution is connected to the second enterprise solution if the first enterprise solution includes, triggers, calls, or otherwise related or mapped to the second enterprise solution, such that at least an aspect of the second enterprise solution is modifiable or triggerable by the first enterprise solution. In some examples, even though a flow record for a first enterprise solution or system is not available, the flow record for the first enterprise solution can be captured in a flow record for one or more second enterprise solutions that are connected to the first enterprise solution. Although in some examples, at least one flow record is included in the flow 107, in other examples, the field of the flow 107 can be empty.

The others field 108 includes a record a sequence of one or more records that each provides relevant information not represented in any of the existing CBOP elements of the CBOP object 100. Although in some examples, at least one record is included in the others field 108, in other examples, the field of the others field 108 can be empty.

In some examples, the CBOP object 100 is managed according to the Solution Development Lifecycle (SDLC) of the enterprise. For example, the CBOP object 100 is created in response to a enterprise solution is first deployed to at least one device, server, or datacenter of the enterprise. In some examples, the CBOP object 100 is updated in a timely manner in response to changes (e.g., software/firmware updates, adding, canceling, or removing hardware, and so on) to the enterprise solution are made. In some examples, the lag time between a change versus the update is minimal (e.g., within a predetermined time period in response to the changes), and when possible, accomplished in real-time (e.g., immediately responsive to the changes without delay).

An SBOM is defined as a record containing information on the supply chain relationship of multiple components used in making a software, such as a nested inventory of the software, ingredients of the software component, and so on. An SBOM may have a Software Package Data Exchange (SPDX®) format which is an open source machine-readable format, a CycloneDX (CDX) format which is also an open source machine-readable format, or a Software Identification (SWID) format. SPDX® defines a standard data communication format for the component and metadata information associated with software packages to be communicated. An SPDX document can be generated for a set of software packages, files, or snippets. The SPDX document can include information of the set of software packages in the SPDX format. CycloneDX is an SBOM specification designed for analyzing software security contexts and supply chain components, and can be used to communicate inventory of software components, external services, and relationships thereof. SWID Tags can be used to track the software installed on managed devices and contain descriptive information of the software. SBOMs are deemed to improve transparency, provenance, and speed at which vulnerabilities can be identified and remediated. SBOMs can reveal a developer or suppliers'application of secure software development practices across the SDLC.

A CBOM improves the security of software, for example, to address web application security risks. A CBOM includes an object model to describe cryptographic assets (e.g., cryptographic materials) and dependencies thereof, given that discovering, managing, and reporting on cryptographic assets is the first step on migrating to quantum-safe systems and applications. CBOM is useful given that cryptography is typically buried deep within components that are used to compose and build systems and applications. Although CBOM discovers and maps cryptographic assets, CBOM is silent on cryptographic processes that use the cryptographic assets.

A SaaSBOM, HBOM, ML-BOM, OBOM, MBOM, VDR, VEX, BOM, BOV, or CDXA described herein are otherwise described in the ECMA International standards, e.g., at https://ecma-international.org/publications-and-standards/standards/ecma-424/. It should be noted that the BOMs are not limited to those specific examples described herein, and that any type of bill of materials can be likewise included in the CBOP object.

FIG. 2 is a flowchart diagram illustrating an example method 200 for generating and using the CBOP object 100, according to various arrangements. The method 200 can be implemented using one or more computing systems (e.g., the computing system 300). In some examples, the one or more computing systems can be operated by an administrator or a user of a device, server, or datacenter of the enterprise. The method 200 depicts the CBOP process for a single given enterprise solution, although the same processes can be implemented for each of multiple enterprise solutions deployed to the devices, servers, or datacenters by the enterprise. The method 200 corresponds to a software development lifecycle (SDLC).

At 210, at least one computing system determines that a enterprise solution is deployed to the at least one sandbox, device, server, or datacenter of an enterprise. This can be the instance in which the enterprise solution is first deployed to the at least one device, server or datacenter, e.g., the enterprise solution is downloaded, loaded, or otherwise installed for the first time to the at least one device, server or datacenter or to a user profile/account authorized to use the at least one device, server or datacenter. A sandbox can be an environment for a device, server, or datacenter of the enterprise that is an isolated environment for development, testing, or debugging. In a sandbox, the at least one computing system runs an enterprise solution in such isolated environment so that the CBOP solution can test and explore all possibly logic flows including error handling which is not done in production environments as its too dangerous. For example, penetration (pen) testing can be incorporated into such testing in the CBOP sandbox environment. Examples of the penetrating testing can be found in X9.111 Pen Testing for Financial Services.

At 220, in response to determining that the enterprise solution is deployed to the least one device, server, or datacenter of the enterprise, at least one computing system creates the CBOP object 100 from that enterprise solution. For example, the at least one computing system evaluates the enterprise solution and extracts information to include in the fields 101-108 of the CBOP object 100. The CBOP object 100 generated in response to first deploying the enterprise solution can be referred to as the first CBOP object. Any updates to the first CBOP object, such as the CBOP object 100 created in response to updating the enterprise solution, can be referred to as a second CBOP object. As used herein, a first enterprise solution (e.g., updates thereof) refers to the subject of a CBOP object 100, and a second enterprise solution refers to another enterprise solution that is associated with (e.g., included in, called by, triggers by) the first enterprise solution.

In some examples, in response to creating the CBOP object 100, the time is recorded in the date field 102. In some examples, the information to identify the enterprise solution, such as the solution name, solution identifier, status (e.g., development, test, production, decommissioned), lifecycle information (e.g., development date, test date, production date, decommissioned date), and so on of the enterprise solution can be recorded in the solution field 103. The information to identify the enterprise solution can be extracted from the metadata of the enterprise solution that is being installed to the device, server, or datacenter of the enterprise.

While crawling through the source code can create list of items and dependencies, the same enterprise solution may behave differently in different enterprise environments and for different products and services of the enterprise. For example, static code review may not be capable of identifying inactive lines of source code that may not be caused to execute within the specific enterprise environment and for the products and services of the enterprise. It is also challenging to identify the cause (or a lack thereof) of function calls layers and layers down the procedure stack. Therefore, in order to extract the information needed for the fields of the CBOP object 100, at least one computing system is configured to monitor, evaluate, and record information extracted from cryptographic processes of the enterprise solution while the enterprise solution is running over a period of time (e.g., an evaluation period) within the environment of the enterprise for one or more products/services of the enterprise.

For example, a monitoring tool can be employed by at least one computing system to record information regarding all calls made by the cryptographic processes of the enterprise solution. Examples of the monitoring tool can include active scans, log systems, sensors, and so on placed at all layers of the software operations of the enterprise solution to record outgoing calls and incoming responses to those calls to determine the information needed to identify the metadata of those calls. The recorded information can be stored in a metadata database of the at least one computing system, in order to map the recorded information to the fields 101-108 of the CBOP object 100. For example, the recorded information can be parsed to identify the information for the version 101, the date 102, the solution 103, and the product 104. With regard to the product 104, for example, at least one of the CBOM or the SBOM can be generated using the information recorded in the metadata database.

The metadata database does not store any cryptographic information, only the metadata for the cryptographic information. For example, for a call for generating an encryption key, the metadata database does not store the actual call request or the encryption key, but rather the metadata information for the encryption key, such as key length, key generation algorithm, and other characteristics of the encryption key. As such, the integrity of the enterprise solution is not affected by the extraction of information Each entry in the metadata database can be associated with a timestamp to identify the time by which the entry is obtained through monitoring the calls (e.g., when the call was made).

Examples of calls made by the cryptographic processes of the enterprise solution include library calls (calls made to certain cryptographic libraries, key stores, secret key stores), external calls (e.g., call to fetch a certificate, call to a website or web service, call to another (second) enterprise solution), cryptographic calls (e.g., call to encrypt data, decrypt data, sign data, verify digital signature, create a hash, etc.), call for a particular protocol (e.g., Transport Layer Security (TLS), IPSec, openSSL), and so on, in order to identify and map the processes of the cryptographic processes of the enterprise solution for the data in motion. In some examples, each enterprise solution can be defined using or corresponds to a protocol, a library, or a type of calls.

In some examples, at least one processor can record information of the metadata of the calls made by a first enterprise solution, where the calls can include a call for performing a specific cryptographic algorithm (identified using a corresponding cryptographic algorithm identifier), a call for generating or using an encryption key with a key length or a hash length, a call for using the encryption key for a particular purpose (e.g., encryption/decryption, HMAC, signing and verification, etc.). The recorded information can include a cryptography record containing the algorithm identifier, the key length, the hash length, the purpose, and the lifecycle information (e.g., metadata such as key generation date, key begin date, key end date) and so on.

In some examples, at least one processor can record information of the metadata of the calls made by a first enterprise solution, where the calls can include a call that references a particular protocol identifier and a protocol version. The recorded information can include a protocol record containing the protocol identifier and the protocol version.

In some examples, at least one processor can record information of the metadata of the calls made by a first enterprise solution, where the calls can include a call that references a particular solution identifier of a different (second) enterprise solution. The recorded information can include a flow record containing the identifier of the second enterprise solution. The second enterprise solution can be any process that generates an output. By virtue of the first enterprise solution calling the second enterprise solution, the first enterprise solution includes, triggers, calls, or is otherwise related or mapped to the second enterprise solution. The second enterprise solution can be any software/firmware process that is provided by a manufacturer (e.g., provider), a cryptographic operation, a cryptographic algorithm, a process defined in a protocol, and so on.

For example, at least one processor can record information of the metadata of the calls made by a first enterprise solution corresponding to a first CBOP object, where the information includes a cryptographic call for checking a digital signature and an external call with a protocol identifier of a TLS protocol (or a library call calling a cryptographic library known to be used in the TLS protocol). Such calls may be made simultaneously or within a predetermined time period (e.g., 0.5 s, 1 s, 2 s, etc.). A relationship can be identified between those calls, such that an inference can be made that the cryptographic call for checking the digital signature is made within executing the TLS protocol connection. In this example, the cryptography field 105 can include a cryptography record of digital signature, the protocol field 106 can include the protocol identifier and version of the TLS protocol, the flow field 107 can include a flow record of checking digital signature or calling cryptographic library (which themselves can be a second enterprise solution).

At 230, the at least one computing system can update cryptographic inventory, cryptographic architecture, and all other relevant documentation. In some examples, the at least one computing system can determine whether the enterprise solution is updated. A enterprise solution can be updated in response to downloading, loading, or otherwise installing a new version or an update of the enterprise solution. For example, the provider or vendor of the enterprise solution can push (e.g., send or request for the device, server, or datacenter to download) the new version of the enterprise solution or an update (e.g., modification, addition, patches, fixes, etc.) of the enterprise solution to the administrator computing system of the enterprise. In response to determining that the enterprise solution is updated, the method 200 returns to 220, where the CBOP object for that enterprise solution is recreated. The updated CBOP object can be referred to as the second CBOP object for the same enterprise solution. The updated CBOP object may be different from the original CBOP object, as the fields of the updated CBOP may be determined based on monitoring the calls by the updated enterprise solution. In response to determining that the enterprise solution is not updated, the method 200 returns to 230.

In some examples, instead of the trigger conditions in the method 200, the generation and updating of the CBOP object can be performed periodically, e.g., every day, every week, every month, and so on. For example, the collection of the metadata of the function calls can be performed periodically. Enterprise solutions can operate differently due to network outages, datacenter changes, software updates, or inputs from other applications, and accordingly the enterprise solution might generate a slightly different CBOP object. For example, using an enterprise solution in a sandbox environment where extensive testing and/or penetration (pen) testing can be safely executed might generate a more complete CBOP object.

The CBOP objects from enterprise solutions employed by the enterprise can reflect the overall health of the cryptographic architectures of the enterprise. For example, the mapping relationships identified in the flow record allows enterprise solutions of a certain category to be identified, for system update or migration to a new system/standard, such as Post-Quantum Cryptography (PQC) where symmetric keys are used. To prepare for PQC, enterprise solutions with cryptography processes that use asymmetric keys are identified. For example, at least one computing system can identify a number of entries in the cryptography record of the enterprise solution that each specifies an asymmetric key (e.g., identified using calls by the enterprise solution that requests, uses, or generates an asymmetric key). The enterprise solutions with the greatest numbers of entries for asymmetric keys in the cryptography record are candidates for modification (e.g., transition the cryptographic algorithm to enable symmetric key usage) or termination. In some examples, in response to the number of entries for asymmetric keys in a cryptography record of the enterprise solution being greater than a threshold, or in response to determining that the number of entries for asymmetric keys in a cryptography record of the enterprise solution being one of the greatest among the enterprise solutions, a notification can be sent to the administrator of the enterprise that the enterprise solution is eligible for transition into symmetric key schemes, terminate, pause, interrupt, and/or uninstall the enterprise solution, and so on.

The enterprise may be interested to increase the entropy (e.g., randomness) used to generate the cryptographic keys, thus the enterprise may be interested to determine which enterprise solution uses keys with less entropy. In some examples, in response to the entropy source in a cryptography record of the enterprise solution being a source known to have low entropy, a notification can be sent to the administrator of the enterprise that the enterprise solution is eligible for entropy upgrade, terminate, pause, interrupt, and/or uninstall the enterprise solution, and so on.

The aggregate CBOP objects across multiple enterprise solutions can further reflect patterns of the cryptographic architectures of the enterprise, such that any deviations from the patterns can be used to determine anomalies. For example, the CBOP objects across multiple enterprise solutions can reflect certain operations (e.g., PIN verification) identified in the flow record to occur frequently within a period of time (e.g., a certain time of the week), according to the timestamps for the flow record entries. At least one computing system can allocate hardware resources to enable sufficient processing power for those identified operations at the identified period of time. Further, in response to determining that a number of certain operations (e.g., PIN verification) being greater than a threshold (e.g., a margin greater than the average number of that operation) for a corresponding time period, a notification can be sent to the administrator of the enterprise to notify the administrator of the anomaly, terminate, pause, interrupt, and/or uninstall the enterprise solution, and so on.

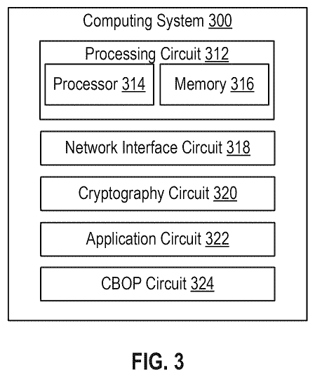

FIG. 3 is a block diagram illustrating an example computing system 300, according to some arrangements. The computing system 300 is shown to include various circuits and logic for implementing the operations described herein. The computing system 300 includes one or more of a processing circuit 312, a network interface circuit 318, a cryptography circuit 320, an application circuit 322, and an CBOP circuit 324. While various circuits, interfaces, and logic with particular functionality are shown, it should be understood that the computing system 300 includes any number of circuits, interfaces, and logic for facilitating the operations described herein. For example, the activities of multiple circuits are combined as a single circuit and implemented on a same processing circuit (e.g., the processing circuit 312), as additional circuits with additional functionality are included.

In some arrangements, the processing circuit 312 includes a processor 314 and a memory 316. The processor 314 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 316 (e.g., Random Access Memory (RAM), Read-Only Memory (ROM), Non-Volatile RAM (NVRAM), Flash Memory, hard disk storage, etc.) stores data and/or computer code for facilitating the various processes described herein. Moreover, the memory 316 is or includes tangible, non-transient volatile memory or non-volatile memory. Accordingly, the memory 316 includes database components, object code components, script components, or any other type of information structure for supporting the various activities and information structures described herein. The processing circuit 312 can be used to implemented one or more of the circuits 318, 320, 322, and 324.

The network interface circuit 318 is configured for and structured to establish a connection and communicate with another device, system, server, or datacenter via the network described herein or another a suitable wired, wireless, or physical connection. The network interface circuit 318 is structured for sending and receiving data over a communication network (e.g., the network over which the communication session is established) or a physical connection (e.g., via a physical connector such as Universal Serial Bus (USB)) for an application executed by the application circuit 322. Accordingly, the network interface circuit 318 includes any of a cellular transceiver (for cellular standards), wireless network transceiver (for 802.11X, ZigBee, Bluetooth, Wi-Fi, or the like), wired network interface, or a combination thereof. For example, the network interface circuit 318 may include wireless or wired network modems, ports, baseband processors, and associated software and firmware.

The application circuit 322 can be used to execute one or more applications or software on the computing system 300 for the enterprise solutions need to be implemented. For example, the application circuit 322 can execute an email server, a mobile banking application server, a website, a word processing application server, a mobile banking application server, a mobile wallet server, a File Transfer Protocol (FTP) server, a virtual machine server, and so on.

The cryptography circuit 320 is executed by the processing circuit 312 in some arrangements. The cryptography circuit 320 performs enterprise solutions of the computing system 300, such as generating cryptographic material, encrypting data, decrypting data, generating a digital signature, verifying a digital signature, in the manner described. The cryptography circuit 320 can execute suitable cryptographic operations, cryptographic algorithms, cryptographic protocols, and flows in which function calls are made in the manner described. The computing system 300 can provide the cryptography circuit 320 in various manners. In some arrangements, the cryptography circuit 320 is a server-based application executable on the computing system 300. In this regard, the user of the computing system 300 has to download the cryptography circuit 320 from an application download server prior to usage. In some arrangements, the cryptography circuit 320 is a web-based interface application provided by an application server. In some arrangements, the cryptography circuit 320 includes an API and/or an SDK provided by the application server that facilitates integration with other applications. In some arrangements, the cryptography circuit 320 is coded into the memory 316 of the computing system 300. All such variations and combinations are intended to fall within the spirit and scope of the present disclosure.

The CBOP circuit 324 is executed by the processing circuit 312 in some arrangements. The CBOP circuit 324 is configured to generate the CBOP object 100 and perform the CBOP method 200, in the manner described. The CBOP circuit 324 can monitor function calls of the enterprise solutions in the manner described. The computing system 300 can provide the CBOP circuit 324 in various manners. In some arrangements, the CBOP circuit 324 is a server-based application executable on the computing system 300. In this regard, the user of the computing system 300 has to download the CBOP circuit 324 from an application download server prior to usage. In some arrangements, the CBOP circuit 324 is a web-based interface application provided by an application server. In some arrangements, the CBOP circuit 324 includes an API and/or an SDK provided by the application server that facilitates integration with other applications. In some arrangements, the CBOP circuit 324 is coded into the memory 316 of the computing system 300. All such variations and combinations are intended to fall within the spirit and scope of the present disclosure. In some examples, the CBOP circuit 324 can implement or include the metadata database.

As utilized herein, the terms “approximately,” “substantially,” and similar terms are intended to have a broad meaning in harmony with the common and accepted usage by those of ordinary skill in the art to which the subject matter of this disclosure pertains. It should be understood by those of ordinary skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

Although only a few arrangements have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter described herein. For example, elements shown as integrally formed may be constructed of multiple components or elements, the position of elements may be reversed or otherwise varied, and the nature or number of discrete elements or positions may be altered or varied. The order or sequence of any method processes may be varied or re-sequenced according to alternative arrangements. Other substitutions, modifications, changes, and omissions may also be made in the design, operating conditions and arrangement of the various exemplary arrangements without departing from the scope of the present disclosure.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

What is claimed is:

1. A method performed by at least one processor, comprising:
creating a first Cryptography Bill of Processes (CBOP object) from a first enterprise solution by monitoring calls made by the first enterprise solution, wherein the CBOP object comprises:
a cryptography record comprising cryptographic operation information of the first enterprise solution;
a protocol record comprising protocol information of at least one protocol used by the first enterprise solution; and
a flow record comprising connection information of at least one second enterprise solution connected to the first enterprise solution;
determining that the first enterprise solution is updated; and
in response to updating the first enterprise solution, creating a second CBOP object for the first enterprise solution.

2. The method of claim 1, wherein the CBOP object is created in response to determining that the first enterprise solution is first deployed to at least one device, server, or datacenter.

3. The method of claim 1, wherein the CBOP object is created in response to determining that at least one of software, firmware, or hardware of the first enterprise solution is being updated.

4. The method of claim 1, wherein the first CBOP object comprises at least one of a Cryptography Bill of Materials (CBOM), Software Bill of Materials (SBOM), Software as a Service Bill of Materials (SaaSBOM), Hardware Bill of Materials (HBOM), Machine Learning Bill of Materials (ML-BOM), Operations Bill of Materials (OBOM), Manufacturing Bill of Materials (MBOM), Vulnerability Disclosure Report (VDR), Vulnerability Exploitability eXchange (VEX), Bill of Materials (BOM), Bill of Vulnerabilities (BOV), or CycloneDX Attestations (CDXA).

5. The method of claim 1, wherein the calls of the first enterprise solution comprises at least one of a function call, library call, external call, cryptographic call, call for a particular protocol.

6. The method of claim 1, wherein the cryptography record comprises at least one of algorithm identifier, size information, usage information, key type, entropy source, or lifecycle information of the first enterprise solution.

7. The method of claim 1, wherein the protocol record comprises at least one of a protocol identifier or a protocol version for the at least one protocol used by the first enterprise solution.

8. The method of claim 1, wherein the flow record comprises the second enterprise solution that is comprised by, trigged by, called by, related to, or mapped to the first solution.

9. A system comprising at least one processor, configured to:
create a first Cryptography Bill of Processes (CBOP) object from a first enterprise solution by monitoring calls made by the first enterprise solution, wherein the CBOP object comprises:
a cryptography record comprising cryptographic operation information of the first enterprise solution;
a protocol record comprising protocol information of at least one protocol used by the first enterprise solution; and
a flow record comprising connection information of at least one second enterprise solution connected to the first enterprise solution;
determine that the first enterprise solution is updated; and
in response to updating the first enterprise solution, creating a second CBOP object for the first enterprise solution.

10. The system of claim 9, wherein the CBOP object is created in response to determining that the first enterprise solution is first deployed to at least one device, server, or datacenter.

11. The system of claim 9, wherein the CBOP object is created in response to determining that at least one of software, firmware, or hardware of the first enterprise solution is being updated.

12. The system of claim 9, wherein the first CBOP object comprises at least one of a Cryptography Bill of Materials (CBOM), Software Bill of Materials (SBOM), Software as a Service Bill of Materials (SaaSBOM), Hardware Bill of Materials (HBOM), Machine Learning Bill of Materials (ML-BOM), Operations Bill of Materials (OBOM), Manufacturing Bill of Materials (MBOM), Vulnerability Disclosure Report (VDR), Vulnerability Exploitability eXchange (VEX), Bill of Materials (BOM), Bill of Vulnerabilities (BOV), or CycloneDX Attestations (CDXA).

13. The system of claim 1, wherein the calls of the first enterprise solution comprises at least one of a function call, library call, external call, cryptographic call, call for a particular protocol.

14. The system of claim 1, wherein the cryptography record comprises at least one of algorithm identifier, size information, usage information, key type, entropy source, or lifecycle information of the first enterprise solution.

15. The system of claim 1, wherein the protocol record comprises at least one of a protocol identifier or a protocol version for the at least one protocol used by the first enterprise solution.

16. The method of claim 1, wherein the flow record comprises the second enterprise solution that is comprised by, trigged by, called by, related to, or mapped to the first solution.

17. At least one non-transitory processor-readable medium comprising processor-readable instructions, such that, when executed, causes at least one processor to:
create a first Cryptography Bill of Processes (CBOP) object from a first enterprise solution by monitoring calls made by the first enterprise solution, wherein the CBOP object comprises:
a cryptography record comprising cryptographic operation information of the first enterprise solution;
a protocol record comprising protocol information of at least one protocol used by the first enterprise solution; and
a flow record comprising connection information of at least one second enterprise solution connected to the first enterprise solution;
determine that the first enterprise solution is updated; and
in response to updating the first enterprise solution, creating a second CBOP object for the first enterprise solution.

18. The non-transitory processor-readable medium of claim 17, wherein the first CBOP object comprises at least one of a Cryptography Bill of Materials (CBOM), Software Bill of Materials (SBOM), Software as a Service Bill of Materials (SaaSBOM), Hardware Bill of Materials (HBOM), Machine Learning Bill of Materials (ML-BOM), Operations Bill of Materials (OBOM), Manufacturing Bill of Materials (MBOM), Vulnerability Disclosure Report (VDR), Vulnerability Exploitability eXchange (VEX), Bill of Materials (BOM), Bill of Vulnerabilities (BOV), or CycloneDX Attestations (CDXA).

19. The non-transitory processor-readable medium of claim 17, wherein
the calls of the first enterprise solution comprises at least one of a function call, library call, external call, cryptographic call, call for a particular protocol; and
wherein the cryptography record comprises at least one of algorithm identifier, size information, usage information, key type, entropy source, or lifecycle information of the first enterprise solution.

20. The non-transitory processor-readable medium of claim 17, wherein
the protocol record comprises at least one of a protocol identifier or a protocol version for the at least one protocol used by the first enterprise solution;
the flow record comprises the second enterprise solution that is comprised by, trigged by, called by, related to, or mapped to the first solution.
